(19) United States
(12) Patent Application Publication
(10) Pub. No.: US 2006/0210171 A1
(43) Pub. Date: Sep. 21, 2006

(54) Image processing apparatus

(75) Inventor: Masaaki Yasunaga, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/080,647

(22) Filed: Mar. 16, 2005

(51) Int. Cl. G06K 7/10; G06K 9/72; G06F 17/30

(52) U.S. Cl. 382/229; 382/321; 707/2

(57) ABSTRACT

When an image processing apparatus receives bitmap information, which includes image information, whose structural element unit is a chapter or a paragraph, first discrimination information and second information that differs from the image information and the first discrimination information, an OCR section outputs text information and meta-information written in the bitmap information, and a sub-title generating section receives the text information and meta-information from the OCR section and generates a sub-title.

### BACKGROUND OF THE INVENTION

1. Field of the Invention

The present invention relates to an image processing apparatus that subjects image data to image processing.

2. Description of the Related Art

With the development of digital technology, an increasing number of documents have been digitized, and management thereof has become an important problem.

In the prior art, an item to be used as a bookmark or an index is manually selected, and hence a bookmark or index is generated.

In addition, when a keyword of a document is to be prepared, such a keyword is manually input or a word with a highest frequency of occurrence in the document is determined to be the keyword. In this case, a small unit of a document, such as a paragraph or a chapter, is not considered. It is considered relatively easy to find a figure/table from a figure/table number appearing in the body of a document. On the other hand, it is relatively difficult to find a figure/table number appearing in the body of the document from a figure/table itself, for example, when one wishes to find a location in the body of a document where the content of Figure/Table A is described. In the prior art, the correlation between a figure/table number appearing in the body of a document and a figure/table itself is not easy to understand.

Jpn. Pat. Appln. KOKAI Publication No. 2002-41497 (Document 1) discloses that document image data that is written in a page-description language is divided into regions and a tag and an attribute value are assigned to the data in each divided region. Thereby, a document image based on a structured description language is generated.

Jpn. Pat. Appln. KOKAI Publication No. 5-89103 (Document 2) discloses that the figure/table number of a figure/table is associated with a figure/table number in the body of a document, and the figure/table number appearing in the body of the document and the figure/table number of the figure/table are renumbered at the same time.

In Document 1, however, a tag, an attribute value, etc. are assigned to data in the region, thereby generating a document image based on a structured description language (a kind of simple database using text and image). This technique makes use of a correlation between text (meta-data) and a figure/table. This technique is not an application to image data that is processed as an object, and is integrated and grouped as a unit of a paragraph, a chapter, etc.

In Document 2, the figure/table number appearing in the body of the document is correlated to the figure/table. Document 2, however, is silent on a method of making use of the figure/table number or figure/table title in the body of the document and the position information of the figure/table.

### BRIEF SUMMARY OF THE INVENTION

The object of an aspect of the present invention is to provide an image processing apparatus capable of making application use of image data by processing the image data as an object and integrating or grouping the image data as a unit of a paragraph, a chapter, etc.

According to an aspect of the present invention, there is provided an image processing apparatus comprising: an OCR section that outputs text information written in input bitmap information; and a sub-title generating section that generates a sub-title from the text information output from the OCR section.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of an image processing apparatus according to a first embodiment of the invention;

FIG. 2 shows an example of the structure of bitmap information that is input to the image processing apparatus;

FIG. 3 shows a detailed structure of an OCR section;

FIG. 4 shows an example of the structure of a sub-title generating section;

FIG. 5 shows another example of the structure of the sub-title generating section;

FIG. 6 shows still another example of the structure of the sub-title generating section;

FIG. 7 is a block diagram that schematically shows the structure of an image processing apparatus according to a second embodiment of the invention;

FIG. 8 illustrates input/output of a region coordinate extraction section;

FIG. 9 is a block diagram that schematically shows the structure of an image processing apparatus according to a third embodiment of the invention; and

FIG. 10 shows an example of the structure of a keyword extraction section.

### DETAILED DESCRIPTION OF THE INVENTION

Embodiments of the present invention will now be described with reference to the accompanying drawings.

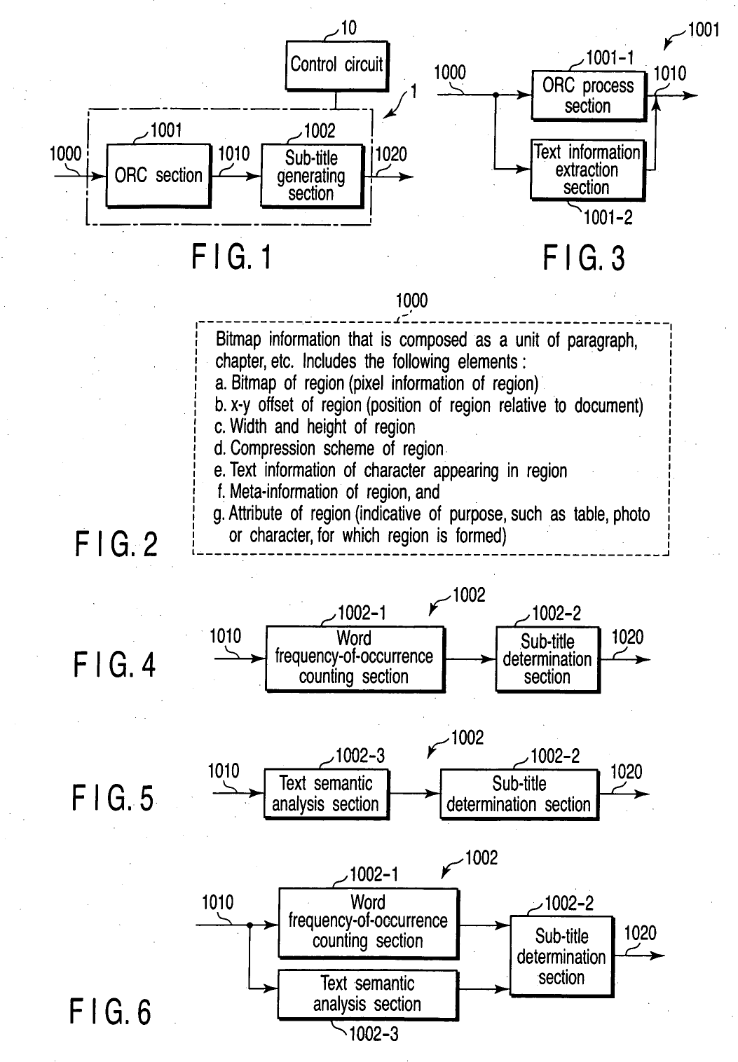

FIG. 1 schematically shows the structure of an image processing apparatus 1 according to a first embodiment of the invention. The image processing apparatus 1 comprises a control circuit 10, an OCR section 1001 and a sub-title generating section 1002.

The control circuit 10 executes an overall control.

The OCR section 1001 outputs text information 1010 that is written in bitmap information 1000.

The sub-title generating section 1002 receives the text information 1010 from the OCR section 1001 and outputs a sub-title 1020.

FIG. 2 shows an example of the structure of the bitmap information 1000 that is input to the image processing apparatus 1. Specifically, the bitmap information 1000 is bitmap information (or a group of associated bitmap information items) that is composed as a unit of a paragraph, a chapter, etc. by a manual operation or by a patented technique, and includes the following elements:
a. a bitmap of a region (pixel information of a region),
b. an x-y offset of a region (position of a region relative to a document),
c. width and height of a region,
d. a compression scheme of a region,
e. text information of a character appearing in a region,
f. meta-information of a region, and
g. an attribute of a region (that is indicative of a purpose, such as a table, a photo or a character, for which a region is formed).

Next, the OCR section 1001 and sub-title generating section 1002, which are characteristic points of the first embodiment, are described with reference to FIGS. 3 to 6.

FIG. 3 shows a detailed structure of the OCR section 1001. The OCR section 1001 comprises an OCR process section 1001-1 and a text information extraction section 1001-2.

As is shown in FIG. 3, the bitmap information 1000, which is input to the OCR section 1001, is directly processed by the OCR process section 1001-1 in normal cases.

On the other hand, in a case where the bitmap information 1000 includes text information and meta-information, the bitmap information is input to the text information extraction section 1001-2 that extracts only text information and meta-information. The text information extraction section 1001-2 extracts only the text information and meta-information from the bitmap information 1000 and outputs the extracted information.

FIG. 4 shows an example of the structure of the sub-title generating section 1002. The sub-title generating section 1002 comprises a word frequency-of-occurrence counting section 1002-1 and a sub-title determination section 1002-2.

As is shown in FIG. 4, in the sub-title generating section 1002, the word frequency-of-occurrence counting section 1002-1 counts the frequency of occurrence of each word in the input text information 1010, and delivers the count information to the sub-title determination section 1002-2. Then, the sub-title determination section 1002-2 outputs (determines) the sub-title 1020.

FIG. 5 shows another example of the structure of the sub-title generating section 1002. The sub-title generating section 1002 comprises a text semantic analysis section 1002-3 and a sub-title determination section 1002-2.

As is shown in FIG. 5, in the sub-title generating section 1002, the word semantic analysis section 1002-3 analyzes the meaning of text information in the input text information 1010, and delivers analysis information to the sub-title determination section 1002-2. Then, the sub-title determination section 1002-2 outputs (determines) the sub-title 1020.

FIG. 6 shows still another example of the structure of the sub-title generating section 1002. The sub-title generating section 1002 comprises both a word frequency-of-occurrence counting section 1002-1 and a text semantic analysis section 1002-3, as well as a sub-title determination section 1002-2 that determines the sub-title.

As is shown in FIG. 6, in the sub-title generating section 1002, the word frequency-of-occurrence counting section 1002-1 counts the frequency of occurrence of each word in the input text information and the word semantic analysis section 1002-3 analyzes the meaning of text information in the input text information. The sub-title determination section 1002-2 receives count information and analysis information, and outputs (determines) the sub-title 1020.

As has been described above, according to the first embodiment, a sub-title of bitmap information (or a group of associated bitmap information items) that is formed as a unit of a paragraph, a chapter, etc. is obtained. Thereby, a document can be managed and retrieved in units of a paragraph or a chapter.

Furthermore, a work procedure for extracting a sub-title in units of a paragraph or a chapter is automated, and the load on the user can be reduced.

Next, a second embodiment of the invention is described.

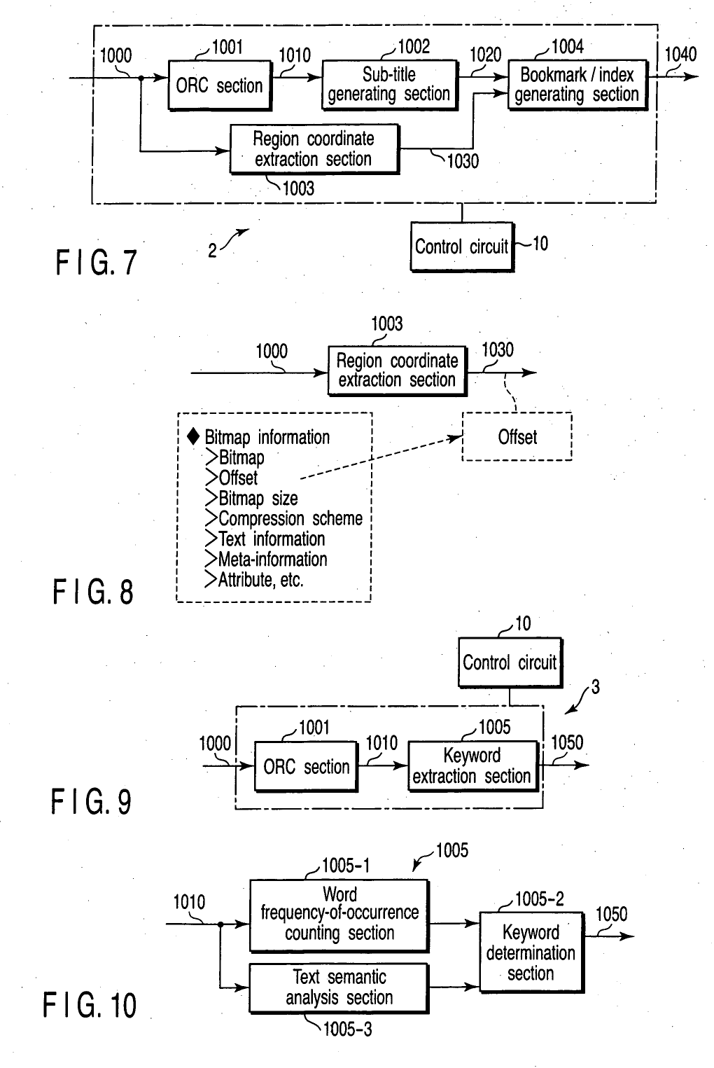

FIG. 7 schematically shows the structure of an image processing apparatus 2 according to the second embodiment. The image processing apparatus 2 comprises a control circuit 10, an OCR section 1001, a sub-title generating section 1002, a region coordinate extraction section 1003, and a bookmark/index generating section 1004.

The control circuit 10 executes an overall control.

The OCR section 1001 receives first bitmap information 1000 is bitmap information (or a group of associated bitmap information items) that is composed as a unit of a paragraph, a chapter, etc. by a manual operation or by a patented technique, and outputs text information 1010 that is written in the first bitmap information 1000.

The sub-title generating section 1002 receives the text information 1010 from the OCR section 1001 and outputs a sub-title 1020.

The region coordinate extraction section 1003 receives the first bitmap information 1000 and extracts position information 1030 relating to the region of the bitmap information.

The bookmark/index generating section 1004 receives the sub-title 1020 from the sub-title generating section 1002 and the position information 1030 relating to the first bitmap information 1000, and generates information such as bookmark information or index information.

The OCR section 1001 and sub-title generating section 1002 are the same as in the first embodiment, and a description thereof is omitted.

Next, the region coordinate extraction section 1003 and bookmark/index generating section 1004 are described.

FIG. 8 shows an example of input/output of the region coordinate extraction section 1003.

The region coordinate extraction section 1003 extracts only offset information from the structural elements of the first bitmap information (group) 1000, and outputs offset information 1030 of the region.

Then, the bookmark/index generating section 1004 receives the sub-title 1020 from the sub-title generating section 1002 and the offset information 1030 from the region coordinate extraction section 1003, and generates bookmark or index information 1040.

As has been described above, according to the second embodiment, the input bitmap information 1000 is composed as a unit of a chapter or a paragraph. Thus, it is possible to automatically generate a bookmark or an index in units of a chapter or a paragraph, and the management of documents is facilitated.

In addition, since the generation of the bookmark/index information is automated, the load on the user can be reduced.

Next, a third embodiment of the invention is described.

FIG. 9 schematically shows the structure of an image processing apparatus 3 according to the third embodiment. The image processing apparatus 3 comprises a control circuit 10, an OCR section 1001 and a keyword extraction section 1005. The control circuit 10 and OCR section 1001 are the same as in the second embodiment, so a description thereof is omitted.

The keyword extraction section 1005 receives text information 1010 from the OCR section 1001, and extracts keyword information 1050.

FIG. 10 shows an example of the structure of the keyword extraction section 1005. The keyword extraction section 1005 comprises a word frequency-of-occurrence counting section 1005-1, a keyword determination section 1005-2, and a text semantic analysis section 1005-3.

As is shown in FIG. 10, the text information 1010 is input to the word frequency-of-occurrence counting section 1005-1 and text semantic analysis section 1005-3.

A count result from the word frequency-of-occurrence counting section 1005-1 and an analysis result from the text semantic analysis section 1005-3 are input to the keyword determination section 1005-2.

The keyword determination section 1005-2 determines a keyword and outputs keyword information 1050.

As has been described above, according to the third embodiment, a keyword can be extracted in units of a paragraph or a chapter, although a keyword is conventionally extracted from the entirety of a document. It is thus possible to easily understand what is asserted and what is described, in units of a paragraph or a chapter.

Furthermore, since the extraction of a keyword is automated, the load on the user can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
an OCR section that outputs text information written in input bitmap information; and
a sub-title generating section that generates a sub-title from the text information output from the OCR section.

2. The image processing apparatus according to claim 1, wherein the bitmap information includes image information, whose structural element unit is a chapter or a paragraph, first discrimination information, and second information that differs from the image information and the first discrimination information.

3. The image processing apparatus according to claim 1, wherein the OCR section includes an OCR process section that processes the bitmap information, and a text information extraction section that extracts only text information in a case where the bitmap information includes the text information.

4. The image processing apparatus according to claim 3, wherein the text information extraction section extracts only text information and meta-information in a case where the bitmap information includes the text information and the meta-information.

5. The image processing apparatus according to claim 1, wherein the sub-title generating section includes a word frequency-of-occurrence counting section that counts a frequency of occurrence of each of words in the text information, and a sub-title determination section that determines a sub-title on the basis of count information from the word frequency-of-occurrence counting section.

6. The.image processing apparatus according to claim 1, wherein the sub-title generating section includes a text semantic analysis section that analyzes a meaning of the text information, and a sub-title determination section that determines a sub-title on the basis of analysis information from the text semantic analysis section.

7. The image processing apparatus according to claim 1, wherein the sub-title generating section includes a word frequency-of-occurrence counting section that counts a frequency of occurrence of each of words in the text information, a text semantic analysis section that analyzes a meaning of the text information, and a sub-title determination section that determines a sub-title on the basis of count information from the word frequency-of-occurrence counting section and analysis information from the text semantic analysis section.

8. An image processing apparatus comprising:
an OCR section that outputs text information written in input bitmap information;
a sub-title generating section that generates a sub-title from the text information output from the OCR section;
a region coordinate extraction section that extracts position information relating to a region of the bitmap information; and
a bookmark/index generating section that generates bookmark information and index information on the basis of the position information relating to the bitmap information, which is extracted by the region coordinate extraction section, and the sub-title that is generated by the sub-title generating section.

9. The image processing apparatus according to claim 8, wherein the region coordinate extraction section extracts only offset information from structural elements of the bitmap information.

10. The image processing apparatus according to claim 8, wherein the bookmark/index generating section generates the bookmark information or index information on the basis of offset information that is extracted by the region coordinate extraction section and the sub-title that is generated by the sub-title generating section.

11. An image processing apparatus comprising:
an OCR section that outputs text information written in input bitmap information; and
a keyword extraction section that extracts a keyword from the text information output from the OCR section.

12. The image processing apparatus according to claim 11, wherein the keyword extraction section includes a word frequency-of-occurrence counting section that counts a frequency of occurrence of each of words in the text information, a text semantic analysis section that analyzes a meaning of the text information, and a keyword determination section that determines a keyword on the basis of count information from the word frequency-of-occurrence counting section and analysis information from the text semantic analysis section.
